(19) United States
(12) Patent Application Publication
(10) Pub. No.: US 2025/0354379 A1
(43) Pub. Date: Nov. 20, 2025

(54) METAL ROOFING SHINGLES

(71) Applicant: GAF Energy LLC, Parsippany, NJ (US)

(72) Inventors: Thierry Nguyen, San Francisco, CA (US); Michael David Kuiper, Newark, CA (US); Gary Rossi, San Francisco, CA (US); Gabriela Bunea, San Jose, CA (US)

(21) Appl. No.: 19/209,617

(22) Filed: May 15, 2025

Related U.S. Application Data
(60) Provisional application No. 63/648,986, filed on May 17, 2024.

(51) Int. Cl. E04D 1/28; E04D 1/00; H02S 20/25

(52) U.S. Cl. CPC E04D 1/28; E04D 1/18; E04D 1/2918; E04D 1/2942; H02S 20/25

(57) ABSTRACT

A roofing system including a plurality of photovoltaic modules installed on a roof deck, where each of the photovoltaic modules includes at least one solar cell, and a plurality of metal roofing shingles installed on the roof deck adjacent the plurality of photovoltaic modules, where the plurality of metal roofing shingles includes at least a first metal roofing shingle and a second metal roofing shingle, where each of the metal roofing shingles includes a first layer that includes a metal material, and a second layer that includes a polymer material, where the second layer includes a nail zone with a plurality of fasteners extending therethrough, fastening the metal roofing shingle to the roof deck, where the second layer is between the roof deck and the first layer.

### CROSS-REFERENCE TO RELATED APPLICATION

This application is a Section 111(a) application relating to and claiming the benefit of commonly owned, co-pending U.S. Provisional Patent Application Ser. No. 63/648,986, filed May 17, 2024, entitled “METAL ROOFING SHINGLE AND ASSOCIATED ROOFING SYSTEM AND METHOD,” the contents of which is incorporated herein by reference in its entirety.

### FIELD

The present invention is directed to a metal roofing shingle and an associated roofing system and method.

### BACKGROUND

Known roofing systems include metal roofing shingles installed on a steep slope roof deck.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a roofing system, comprising: a roof deck; a plurality of photovoltaic modules installed on the roof deck, wherein each of the photovoltaic modules comprises at least one solar cell; and a plurality of metal roofing shingles installed on the roof deck adjacent the plurality of photovoltaic modules, wherein the plurality of metal roofing shingles comprises at least a first metal roofing shingle and a second metal roofing shingle, wherein each of the metal roofing shingles comprises: a first layer, wherein the first layer comprises a metal material, and a second layer, wherein the second layer comprises a polymer material, wherein the second layer includes a nail zone comprising a plurality of fasteners extending therethrough, fastening the metal roofing shingle to the roof deck, wherein the second layer is between the roof deck and the first layer.

In some embodiments, the roof deck comprises a sloped roof deck.

In some embodiments, the metal material comprises steel.

In some embodiments, the polymer material comprises at least one of thermoplastic polyolefin (TPO) or ethylene tetrafluoroethylene (ETFE).

In some embodiments, the second layer further comprises an intumescent material.

In some embodiments, the intumescent material comprises expandable graphite.

In some embodiments, the second layer directly contacts the roof deck.

In some embodiments, an end of the first layer folds over an end of the second layer.

In some embodiments, the second layer of the second metal roofing shingle extends beyond an end of the first layer of the second metal roofing shingle, thereby defining a sidelap, and the second metal roofing shingle overlays the sidelap of the first metal roofing shingle.

In some embodiments, the first layer comprises a first channel and a second channel on opposite ends of the first layer, and the first channel of the first metal roofing shingle is positioned within the second channel of the second metal roofing shingle.

In some embodiments, the roofing system further comprises a plurality of fasteners, wherein the plurality of fasteners comprises at least a first fastener and a second fastener, wherein the first fastener penetrates the nail zone of the first metal roofing shingle and the roof deck, thereby installing the first metal roofing shingle on the roof deck, wherein the second fastener penetrates the nail zone of the second metal roofing shingle and the roof deck, thereby installing the second metal roofing shingle on the roof deck.

In some embodiments, the first fastener penetrates the first layer of the first metal roofing shingle.

In some embodiments, the first fastener does not penetrate the first layer of the first metal roofing shingle.

In some embodiments, the first layer of the first metal roofing shingle includes an embossed surface.

In some embodiments, each of the metal roofing shingles further comprises a third layer, wherein the third layer comprises a polymer material, wherein the first layer is between the second layer and the third layer.

In some embodiments, the third layer comprises at least one of thermoplastic polyolefin (TPO), ethylene tetrafluoroethylene (ETFE), or styrene-butadiene-styrene (SBS).

In some embodiments, the present invention includes a method, comprising: obtaining a plurality of photovoltaic modules and a plurality of metal roofing shingles, wherein the plurality of photovoltaic modules includes at least a first photovoltaic module, wherein each of the photovoltaic modules comprises at least one solar cell, wherein the plurality of metal roofing shingles comprises at least a first metal roofing shingle and a second metal roofing shingle, wherein each of the metal roofing shingles comprises: a first layer, wherein the first layer comprises a metal material, and a second layer, wherein the second layer comprises a polymer material, wherein the second layer includes a nail zone configured to receive a fastener; installing the first photovoltaic module on a roof deck; and installing the first metal roofing shingle and the second metal roofing shingle on the roof deck, adjacent to the first photovoltaic module, so that: the second layer of the first metal roofing shingle is between the roof deck and the first layer of the first metal roofing shingle, and the second layer of the second metal roofing shingle is between the roof deck and the first layer of the second metal roofing shingle.

In some embodiments, the installing the first metal roofing shingle and the second metal roofing shingle on the roof deck comprises: installing the first metal roofing shingle adjacent to a side of the first photovoltaic module, in a first row on the roof deck; and installing the second metal roofing shingle adjacent to the side of the first photovoltaic module, in a second row on the roof deck, wherein the second row is above the first row on the roof deck.

In some embodiments, the installing the first metal roofing shingle and the second metal roofing shingle on the roof deck comprises: installing the first metal roofing shingle adjacent to a side of the first photovoltaic module, in a first row on the roof deck; and installing the second metal roofing shingle adjacent to the first metal roofing shingle, in the first row on the roof deck.

In some embodiments, the installing the first metal roofing shingle and the second metal roofing shingle on the roof deck comprises: penetrating, with a first fastener, both of: the nail zone of the second layer of the first metal roofing shingle, and the roof deck, and penetrating, with a second fastener, both of: the nail zone of the second layer of the second metal roofing shingle, and the roof deck.

### BRIEF DESCRIPTION OF THE FIGURES

This section refers to the drawings that form a part of this disclosure, and which illustrate some of the embodiments of structure, materials, and/or methods of the present invention described herein.

FIG. 1A is a schematic top view of a roofing system including a plurality of metal roofing shingles installed on a roof deck in a staggered configuration, in accordance with some embodiments.

FIG. 1B is a schematic top view of a roofing system including a plurality of metal roofing shingles installed on a roof deck in an array configuration, in accordance with some embodiments.

FIG. 2 is a schematic side view of some of the metal roofing shingles installed on the roof deck, taken along line II-II from FIG. 1A, in accordance with some embodiments.

FIG. 3 is a schematic top view of one of the metal roofing shingles of FIG. 1A, in accordance with some embodiments.

FIG. 4 is a schematic bottom view of the metal roofing shingle of FIG. 3, in accordance with some embodiments.

FIG. 5 is a schematic top view of one of the metal roofing shingles of FIG. 1A, in accordance with some embodiments.

FIG. 6 is a schematic side view of one of the metal roofing shingles of FIG. 1A, in accordance with some embodiments.

FIG. 7 is a schematic top view of the metal roofing shingle of FIG. 6, in accordance with some embodiments.

FIG. 8 is a schematic bottom view of the metal roofing shingle of FIG. 6, in accordance with some embodiments.

FIG. 9 is a schematic top view of one of the metal roofing shingles of FIG. 1A, in accordance with some embodiments of the invention.

FIG. 10 is a schematic bottom view of the metal roofing shingle of FIG. 9, in accordance with some embodiments of the invention.

FIG. 11 is a schematic side view of one of the metal roofing shingles of FIG. 1A, in accordance with some embodiments of the invention.

FIG. 12 is a schematic top view of the metal roofing shingle of FIG. 11, in accordance with some embodiments of the invention.

FIG. 13 is a schematic bottom view of the metal roofing shingle of FIG. 11, in accordance with some embodiments of the invention.

FIGS. 14 and 15 are a top plan view and a schematic side sectional view of some embodiments of a roofing shingle.

FIGS. 16A through 16D are side views of some embodiments of a layer of a roofing shingle.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

As used herein, a “steep slope” roof or roof deck is a roof or roof deck that has a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck is a roof or roof deck that has a pitch greater than zero (that is, the roof or roof deck is not flat), but the pitch is less than that of a steep slope roof or roof deck.

In some embodiments, the present invention provides at least one metal roofing shingle. In some embodiments, the present invention provides a roofing system in which the at least one metal roofing shingle is installed on a roof deck. In some embodiments, the present invention provides a method, such as but not limited to a method of installing the roofing system including the at least one metal roofing shingle on the roof deck.

In some embodiments, the roof deck is a sloped roof deck. In some embodiments, the sloped roof deck is a steep slope roof deck.

In some embodiments, the roofing system includes at least one metal roofing shingle and at least one photovoltaic module installed on the roof deck. In some embodiments, the photovoltaic module includes at least one solar cell. In some embodiments, the roofing system includes a plurality (e.g., two or more) of the metal roofing shingles, and/or a plurality (e.g., two or more) of the photovoltaic modules. In some embodiments, one or more of the metal roofing shingles are installed adjacent one or more of the photovoltaic modules on the roof deck. In some embodiments, one or more of the metal roofing shingles are installed spaced apart from one or more of the photovoltaic modules on the roof deck.

In some embodiments, the metal roofing shingle includes a first layer and a second layer. In some embodiments, the first layer is an uppermost layer of the metal roofing shingle when installed on the roof deck. In some embodiments, the second layer is a bottommost later of the metal roofing shingle when installed on the roof deck. In some embodiments, the second layer is between the first layer and the roof deck, when the metal roofing shingle is installed on the roof deck.

In some embodiments, the first layer includes a metal material. In some embodiments, the metal material includes at least one of steel, stainless steel, iron, galvanized iron, copper, aluminum, lead and/or tin coated steel, lead, and/or zinc, and/or combinations thereof.

In some embodiments, the second layer includes a polymer material. In some embodiments, the polymer material includes at least one of thermoplastic polyolefin (TPO), ethylene propylene diene monomer rubber (EPDM), polyethylene terephthalate (PET), ethylene tetrafluoroethylene (ETFE), styrene-butadiene-styrene (SBS), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), polyphenylsulfone (PPSU), cyclic olefin copolymers (CPCs), and/or polyimide, and/or combinations thereof.

In some embodiments, the second layer includes an intumescent material. In some embodiments, the second layer includes the polymer and the intumescent material. In some embodiments, the intumescent material includes graphite. In some embodiments, the graphite includes expandable graphite.

In some embodiments, the first layer and the second layer are adhered to one another with an adhesive. In some embodiments, the adhesive includes at least one of an epoxy adhesive, a polyurethane adhesive, an acrylic adhesive, an ultraviolet radiation cured adhesive, a silicone-containing adhesive, a silyl modified polymer, a silane terminated polymer, natural rubber, a polyolefin polymer, a poly-alpha-olefin (APAO/APO) polymer, a polyamide polyvinyl acetate, a poly vinyl acetate, a polyvinyl alcohol, an ethylene vinyl acetate, a styrene, a styrene-isoprene-styrene (SIS) polymer, a styrene-butadiene-styrene (SBS) polymer, a styrene-ethylene/butylene-styrene (SEBS) polymer, a styrene-butadiene rubber (SBR), a polyamide, a polyester, a polyester amide, an ethylene acrylic, a butyl adhesive, and/or a butyl rubber, and/or combinations thereof. In some embodiments, the first layer and the second layer are fastened to one another with at least one fastener. In some embodiments, the first layer and the second layer are fastened to one another with a plurality of fasteners. In some embodiments, the fastener is a rivet, screw, bolt, clip, staple, or other mechanical fastener. In some embodiments, the first layer and the second layer are laminated to one another.

In some embodiments, a length (e.g., a largest dimension) of the first layer is 50 inches. In some embodiments, the length is 55 inches. In some embodiments, the length is 60 inches. In some embodiments, the length is 65 inches. In some embodiments, the length is 50 inches to 65 inches. In some embodiments, the length is 55 inches to 65 inches. In some embodiments, the length is 50 inches to 60 inches.

In some embodiments, a thickness of the second layer is 20 mil to 100 mil. In some embodiments, the thickness is 40 mil to 100 mil. In some embodiments, the thickness is 60 mil to 100 mil. In some embodiments, the thickness is 80 mil to 100 mil. In some embodiments, a thickness of the second layer is 20 mil to 80 mil. In some embodiments, the thickness is 40 mil to 80 mil. In some embodiments, the thickness is 60 mil to 80 mil. In some embodiments, a thickness of the second layer is 20 mil to 60 mil. In some embodiments, the thickness is 40 mil to 60 mil. In some embodiments, the thickness is 20 mil to 40 mil.

In some embodiments, the second layer includes a nail zone indicating where to penetrate the metal roofing shingle with one or more fasteners, to install the metal roofing shingle on the roof deck. For example, in some embodiments, the second layer includes one or more paint lines and/or one or more other markings. In some embodiments, the fasteners include at least one of a nail, screw, rivet, clip, and/or staple, and/or other mechanical fastener, extending through the nail zone. In some embodiments, the metal roofing shingle is adhered to the roof deck, in addition to or in place of being mechanically fastened to the roof deck. In some embodiments, the roofing system includes the fastener extending through the nail zone without extending through the first layer of the metal roofing shingle. In some embodiments, the roofing system includes the fastener extending through the nail zone and extending through the first layer of the metal roofing shingle. In some embodiments, the fastener extends through the roof deck.

In some embodiments, the second layer directly contacts the roof deck, such that the roofing system does not include an underlayment between the metal roofing shingle and the roof deck. In some embodiments, the roofing system includes an underlayment between the metal roofing shingle and the roof deck, and thus no layer of the metal roofing shingle directly contacts the roof deck.

In some embodiments, the second layer of the metal roofing shingle extends beyond an end of the first layer, thereby defining a sidelap. In some embodiments, the roofing system includes two metal roofing shingles installed on the roof deck, and the second metal roofing shingle overlays the sidelap of the first metal roofing shingle.

In some embodiments, a dimension of the sidelap (e.g., a length of the sidelap, which is measured in a direction parallel to the eave of the roof deck, and/or a width, which is measured in a direction parallel to the rake of the roof deck) is 2 inches. In some embodiments, the sidelap dimension is 3 inches. In some embodiments, the sidelap dimension is 4 inches. In some embodiments, the sidelap dimension is 5 inches. In some embodiments, the sidelap dimension is 6 inches. In some embodiments, the sidelap dimension is greater than 6 inches. In some embodiments, the sidelap dimension is 2 inches to 6 inches. In some embodiments, the sidelap dimension is 2 inches to 5 inches. In some embodiments, the sidelap dimension is 2 inches to 4 inches. In some embodiments, the sidelap dimension is 3 inches to 6 inches. In some embodiments, the sidelap dimension is 3 inches to 5 inches. In some embodiments, the sidelap dimension is 4 inches to 6 inches.

In some embodiments, the second layer of the second metal roofing shingle extends beyond an end of the first layer of the second metal roofing shingle, thereby defining a headlap.

In some embodiments, a dimension of the headlap (e.g., a length of the headlap, which is measured in a direction parallel to the eave of the roof deck, and/or a width, which is measured in a direction parallel to the rake of the roof deck) is 2 inches. In some embodiments, the headlap dimension is 3 inches. In some embodiments, the headlap dimension is 4 inches. In some embodiments, the headlap dimension is 5 inches. In some embodiments, the headlap dimension is 6 inches. In some embodiments, the headlap dimension is greater than 6 inches. In some embodiments, the headlap dimension is 2 inches to 6 inches. In some embodiments, the headlap dimension is 2 inches to 5 inches. In some embodiments, the headlap dimension is 2 inches to 4 inches. In some embodiments, the headlap dimension is 3 inches to 6 inches. In some embodiments, the headlap dimension is 3 inches to 5 inches. In some embodiments, the headlap dimension is 4 inches to 6 inches.

In some embodiments, the first layer of the metal roofing shingle includes a first end. In some embodiments, the first end of the first layer extends beyond the second layer. In some embodiments, the first end of the first layer is folded over the second layer. In some embodiments, the folded first end of the first layer provides a first channel. In some embodiments, the first end and/or the first channel is at a bottommost end of the metal roofing shingle when installed on the roof deck. In some embodiments, the first end contacts the roof deck.

In some embodiments, the first layer of the metal roofing shingle includes a second end. In some embodiments, the second end is opposite the first end. In some embodiments, the second end of the first layer is folded over. In some embodiments, the folded second end of the first layer provides a second channel on an opposite end of the first layer to the first channel. In some embodiments, the second end and/or the second channel is at a uppermost end of the metal roofing shingle when installed on the roof deck.

In some embodiments, in the roofing system including the metal roofing shingles in multiple rows on the roof deck, the ends of the metal roofing shingles in one row are installed or otherwise positioned within the channels of the metal roofing shingles in another row.

In some embodiments, the roofing system includes a plurality of fasteners. In some embodiments, the plurality of fasteners includes at least a first fastener and a second fastener. In some embodiments, the first fastener penetrates the nail zone of one metal roofing shingle and the roof deck, and the second fastener penetrates the nail zone of another metal roofing shingle and the roof deck, thereby installing both metal roofing shingles on the roof deck. In some embodiments, a fastener penetrates the first layer of the metal roofing shingle. In some embodiments, a fastener does not penetrate the first layer of the metal roofing shingle.

In some embodiments, the first layer of the first metal roofing shingle includes an embossed surface. In some embodiments, the embossed surface includes one or more patterns. In some embodiments, the pattern includes grain lines. In some embodiments, the grain lines are vertical grain lines. In some embodiments, the pattern includes pebble grains. In some embodiments, the first layer is painted.

In some embodiments, the metal roofing shingle further includes a third layer. In some embodiments, the third layer is an uppermost layer of the metal roofing shingle when installed on the roof deck. In some embodiments, the second layer is the bottommost later of the metal roofing shingle when installed on the roof deck. In some embodiments, the first layer is between the third layer and the second layer, when the metal roofing shingle is installed on the roof deck.

In some embodiments, the third layer includes a polymer material. In some embodiments, the polymer material includes at least one of thermoplastic polyolefin (TPO), ethylene propylene diene monomer rubber (EPDM), polyethylene terephthalate (PET), ethylene tetrafluoroethylene (ETFE), styrene-butadiene-styrene (SBS), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), polyphenylsulfone (PPSU), cyclic olefin copolymers (CPCs), and/or polyimide, and/or combinations thereof.

In some embodiments, the first layer and the third layer are adhered to one another with an adhesive. In some embodiments, the adhesive is one or more of the adhesives listed above. In some embodiments, the first layer and the third layer are laminated to one another.

In some embodiments, the method includes obtaining one or more of the photovoltaic modules, and/or one or more of the metal roofing shingles. In some embodiments, the method includes installing a first photovoltaic module on the roof deck. In some embodiments, the method includes installing a first metal roofing shingle and a second metal roofing shingle on the roof deck, adjacent to the first photovoltaic module, so that the second layer of the first metal roofing shingle is between the roof deck and the first layer of the first metal roofing shingle, and the second layer of the second metal roofing shingle is between the roof deck and the first layer of the second metal roofing shingle.

In some embodiments, the installing the first metal roofing shingle and the second metal roofing shingle on the roof deck includes installing the first metal roofing shingle adjacent to a side of the first photovoltaic module, in a first row on the roof deck, and/or installing the second metal roofing shingle adjacent to the side of the first photovoltaic module, in a second row on the roof deck, wherein the second row is above the first row on the roof deck.

In some embodiments, the installing the first metal roofing shingle and the second metal roofing shingle on the roof deck includes installing the first metal roofing shingle adjacent to a side of the first photovoltaic module, in a first row on the roof deck, and/or installing the second metal roofing shingle adjacent to the first metal roofing shingle, in the first row on the roof deck.

In some embodiments, the installing the first metal roofing shingle and the second metal roofing shingle on the roof deck includes penetrating, with a first fastener, both of the nail zone of the second layer of the first metal roofing shingle, and the roof deck, and penetrating, with a second fastener, both of the nail zone of the second layer of the second metal roofing shingle, and the roof deck.

In some embodiments, one or more of the photovoltaic modules, except as otherwise described or illustrated herein, includes a structure, composition, component, and/or function similar to those of one or more embodiments of the photovoltaic modules and photovoltaic shingles disclosed, shown, and/or described in any or all of: U.S. application Ser. No. 17/831,307, filed Jun. 2, 2022, titled “Roofing Module System,” and published under U.S. Patent Application Publication No. 2022-0393637 on Dec. 8, 2022; U.S. application Ser. No. 18/169,718, filed Feb. 15, 2023, titled “Roofing Module System,” and published under U.S. Patent Application Publication No. 2023-0203815 on Jun. 29, 2023; PCT International Patent Publication No. WO 2022/051593, Application No. PCT/US2021/049017, published Mar. 10, 2022, titled “Building Integrated Photovoltaic System,” owned by GAF Energy LLC; and/or U.S. Pat. No. 11,251,744 to Bunea et al., issued Feb. 15, 2022, titled “Photovoltaic Shingles and Methods of Installing Same”; and the disclosures of each of which are incorporated by reference herein in their entireties, with certain different and/or additional features as described herein.

In some embodiments, the roofing system and/or method includes one or more roofing shingles, other than the metal roofing shingles and the photovoltaic modules. In some embodiments, the roofing shingles may be installed adjacent to, above, and/or below the metal roofing shingles and/or the photovoltaic modules. In some embodiments, one or more of the roofing shingles, except as otherwise described or illustrated, includes a structure, composition, component, and/or function similar to those of one or more embodiments of a non-photovoltaic module and/or another roofing material disclosed, shown, and/or described in either or both of U.S. application Ser. No. 17/831,307, filed Jun. 2, 2022, titled “Roofing Module System,” and published under U.S. Patent Application Publication No. 2022-0393637 on Dec. 8, 2022; and/or U.S. application Ser. No. 18/169,718, filed Feb. 15, 2023, titled “Roofing Module System,” and published under U.S. Patent Application Publication No. 2023-0203815 on Jun. 29, 2023; and/or U.S. application Ser. No. 18/352,894, filed Jul. 14, 2023, titled “Solar Roofing System with Fiber Composite Roofing Shingles,” and the disclosures of each of which are incorporated by reference herein in their entireties, with certain different and/or additional features as described herein.

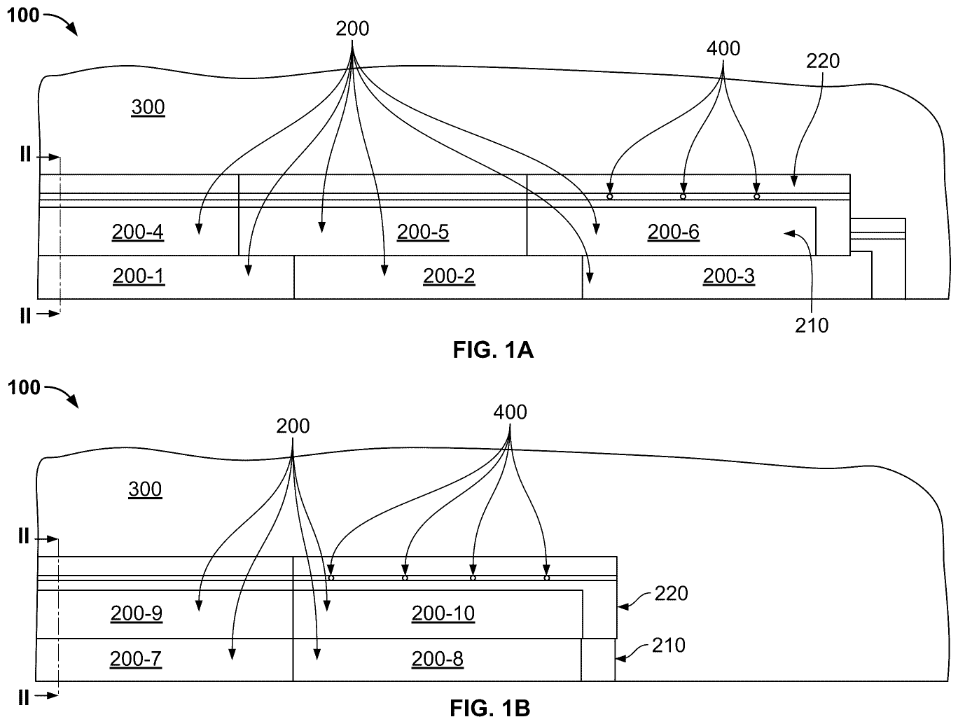

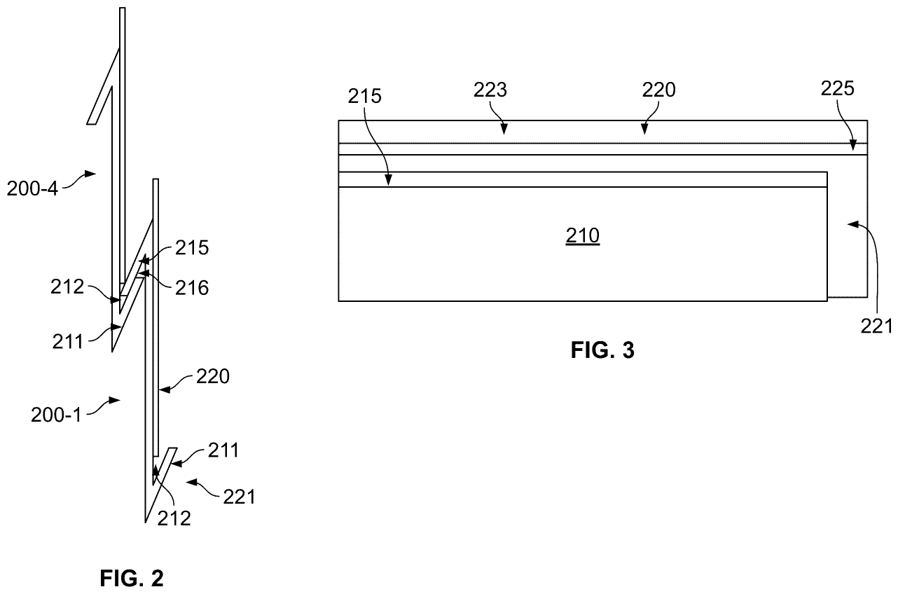

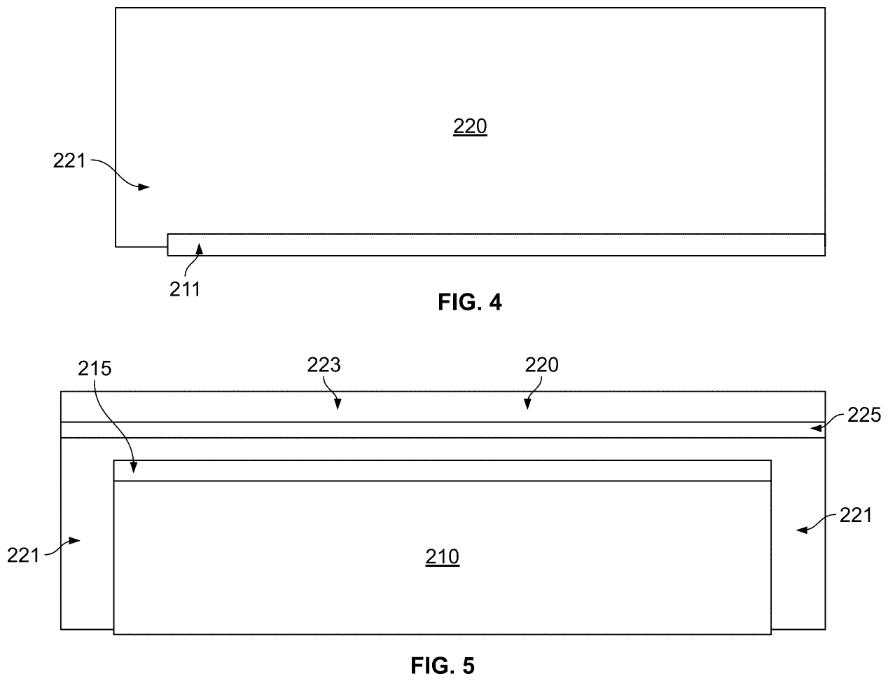

With reference to the drawings, FIGS. 1A and 1B are schematic top views of a roofing system 100 including metal roofing shingles 200 installed on a roof deck 300, with fasteners 400 extending therethrough, in a staggered configuration and an array configuration, respectively, FIG. 2 is a schematic side view of some of the metal roofing shingles 200 installed on the roof deck 300, taken along line II-II from FIG. 1A, FIG. 3 is a schematic top view of one of the metal roofing shingles 200 of FIG. 1A, and FIG. 4 is a schematic bottom view of the metal roofing shingle 200 of FIG. 3, in accordance with some embodiments of the invention.

FIG. 1A shows an embodiment in which six (6) metal roofing shingles 200 are installed on the roof deck 300. In some embodiments, as FIG. 1A shows, the metal roofing shingles 200 are installed in a staggered or offset configuration, such that seams between adjacent shingles in a same shingle row are not aligned with seam between adjacent shingles in a shingle row that is vertically adjacent (e.g., directly above or directly below) that row. In FIG. 1A, the metal roofing shingles 200 include a first metal roofing shingle 200-1, a second metal roofing shingle 200-2, a third metal roofing shingle 200-3, a fourth metal roofing shingle 200-4, a fifth metal roofing shingle 200-5, and a sixth metal roofing shingle 200-6, installed in two rows on the roof deck 300. It is understood that in some embodiments, the roofing system 100 includes a greater number or a lesser number of metal roofing shingles 200 installed on the roof deck 300. In some embodiments, the roofing system 100 includes a greater number or a lesser number of rows of the metal roofing shingles 200 on the roof deck 300. In some embodiments, the roofing system 100 includes a greater number or lesser number of the metal roofing shingles 200 in one or more of the rows on the roof deck 300. In some embodiments, the roofing system 100 includes one or more photovoltaic modules, each including at least one solar cell, installed on the roof deck 300. In some embodiments, the photovoltaic modules are installed adjacent one or more of the metal roofing shingles 200. In some embodiments, the photovoltaic modules are installed spaced apart from one or more of the metal roofing shingles 200. In some embodiments, the roofing system 100 includes one or more roofing shingles other than the metal roofing shingles 200 and the photovoltaic modules installed on the roof deck 300. In some embodiments, the photovoltaic modules are installed in an array configuration. In some embodiments, the photovoltaic modules are installed in a staggered or offset configuration.

FIG. 1B shows an embodiment in which four (4) metal roofing shingles 200 are installed on the roof deck 300. In some embodiments, as FIG. 1B shows, the metal roofing shingles 200 are installed in an array configuration, such that seams between adjacent shingles in a same shingle row are aligned with seam between adjacent shingles in a shingle row that is vertically adjacent (e.g., directly above or directly below) that row. In FIG. 1B, the metal roofing shingles 200 include a seventh metal roofing shingle 200-7, an eighth metal roofing shingle 200-8, a ninth metal roofing shingle 200-9, and a tenth metal roofing shingle 200-10, installed in two rows on the roof deck 300.

In some embodiments, one or more of the metal roofing shingles 200 includes a first layer 210 and a second layer 220. In some embodiments, the first layer 210 and/or the second layer 220 of the metal roofing shingle 200 is as described above. Thus, in some embodiments, the first layer 210 of the metal roofing shingle 200 is a metal layer, and/or the second layer 220 of the metal roofing shingle 200 is a polymer layer.

As FIGS. 1A, 1B, 2, 3, and 4 show, in some embodiments, a first end 211 of the first layer 210 is folded over the second layer 220. In some embodiments, the first end 211 is a bottommost surface of the metal roofing shingle 200 when installed on the roof deck 300. In some embodiments, the first layer 210 includes a first channel 212 formed or otherwise provided by the folded first end 211. In some embodiments, the first layer 210 includes a second end 215 that is opposite the first end 211. In some embodiments, the second end 215 is folded over. In some embodiments, the first layer 210 includes a second channel 216 formed or otherwise provided by the folded second end 215. In some embodiments, the second channel 216 is opposite the first channel 212. In some embodiments, the second layer 220 extends beyond the first layer 210, thereby defining a sidelap 221 of the second layer 220. In some embodiments, the second layer 220 extends beyond the first layer 210, thereby defining a headlap 223 of the second layer 220.

In some embodiments, as FIG. 1A shows, the first metal roofing shingle 200-1, the second metal roofing shingle 200-2, and the third metal roofing shingle 200-3 are installed in a first row on the roof deck 300. In some embodiments, there are one or more rows that include one or more metal roofing shingles 200, below the first row that includes the first metal roofing shingle 200-1, the second metal roofing shingle 200-2, and the third metal roofing shingle 200-3. In some embodiments, there are more of the metal roofing shingles 200 installed to the left of the first metal roofing shingle 200-1.

In some embodiments, in the roofing system 100, the first metal roofing shingle 200-1 is installed prior to installation of the second metal roofing shingle 200-2, and the second metal roofing shingle 200-2 is installed prior to the installation of the third metal roofing shingle 200-3. In some embodiments, the first metal roofing shingle 200-1 and the second metal roofing shingle 200-2 are installed such that an end of the first layer 210 of the first metal roofing shingle 200-1 contacts an end of the first layer 210 of the second metal roofing shingle 200-2, the first layers 210 abutting against one another to form a butt joint between the first metal roofing shingle 200-1 and the second metal roofing shingle 200-2. In some embodiments, when the first layer 210 of the first metal roofing shingle 200-1 abuts the first layer 210 of the second metal roofing shingle 200-2, the second metal roofing shingle 200-2 overlaps the sidelap 221 of the first metal roofing shingle 200-1.

In some embodiments, the second metal roofing shingle 200-2 and the third metal roofing shingle 200-3 are installed in the first row on the roof deck 300, such that another end of the first layer 210 of the second metal roofing shingle 200-2 contacts an end of the first layer 210 of the third metal roofing shingle 200-3, the first layers 210 abutting against one another to form a butt joint between the second metal roofing shingle 200-2 and the third metal roofing shingle 200-3. In some embodiments, the third metal roofing shingle 200-3 overlap the sidelap 221 of the second metal roofing shingle 200-2.

In some embodiments, the fourth metal roofing shingle 200-4, the fifth metal roofing shingle 200-5, and the sixth metal roofing shingle 200-6 are installed in a second row on the roof deck 300, where the second row is above the first row. In some embodiments, there are one or more rows above the second row of FIG. 1A. In some embodiments, there are more of the metal roofing shingles installed to the left of the fourth metal roofing shingle 200-4. In some embodiments, the fourth metal roofing shingle 200-4 is installed prior to installation of the fifth metal roofing shingle 200-5, and the fifth metal roofing shingle 200-5 is installed prior to the installation of the sixth metal roofing shingle 200-6. In some embodiments, the fourth metal roofing shingle 200-4 and the fifth metal roofing shingle 200-5 are installed in the second row on the roof deck 300, such that an end of the first layer 210 of the fourth metal roofing shingle 200-4 contacts an end of the first layer 210 of the fifth metal roofing shingle 200-5. In some embodiments, the fifth metal roofing shingle 200-5 overlap the sidelap 221 of the fourth metal roofing shingle 200-4.

In some embodiments, the fifth metal roofing shingle 200-5 and the sixth metal roofing shingle 200-6 are installed in the second row on the roof deck 300, such that an end of the first layer 210 of the fifth metal roofing shingle 200-5 contacts an end of the first layer 210 of the sixth metal roofing shingle 200-6. In some embodiments, the sixth metal roofing shingle 200-6 overlaps the sidelap 221 of the fifth metal roofing shingle 200-5.

In some embodiments, as FIG. 1A shows, the rows are installed staggered relative to one another such that, for example, the butt joints between the metal roofing shingles 200 in one row are not aligned with the butt joints between the metal roofing shingles 200 in the row that is immediately above and/or immediately below.

In some embodiments, as FIG. 1B shows, the seventh metal roofing shingle 200-7 and the eighth metal roofing shingle 200-8 are installed in a first row on the roof deck 300. In some embodiments, there are one or more rows that include one or more metal roofing shingles 200, below the first row that includes the seventh metal roofing shingle 200-7 and the eighth metal roofing shingle 200-8. In some embodiments, there are more of the metal roofing shingles 200 installed to the left of the seventh metal roofing shingle 200-7.

In some embodiments, in the roofing system 100, the seventh metal roofing shingle 200-7 is installed prior to installation of the eighth metal roofing shingle 200-8. In some embodiments, the seventh metal roofing shingle 200-7 and the eighth metal roofing shingle 200-8 are installed such that an end of the first layer 210 of the seventh metal roofing shingle 200-7 contacts an end of the first layer 210 of the eighth metal roofing shingle 200-8, the first layers 210 abutting against one another to form a butt joint between the seventh metal roofing shingle 200-7 and the eighth metal roofing shingle 200-8. In some embodiments, when the first layer 210 of the seventh metal roofing shingle 200-7 abuts the first layer 210 of the eighth metal roofing shingle 200-8, the eighth metal roofing shingle 200-8 overlaps the sidelap 221 of the seventh metal roofing shingle 200-7.

In some embodiments, the ninth metal roofing shingle 200-9 and the tenth metal roofing shingle 200-10 are installed in a second row on the roof deck 300, where the second row is above the first row. In some embodiments, there are one or more rows above the second row of FIG. 1B. In some embodiments, there are more of the metal roofing shingles installed to the left of the ninth metal roofing shingle 200-9. In some embodiments, the ninth metal roofing shingle 200-9 is installed prior to installation of the tenth metal roofing shingle 200-105. In some embodiments, the ninth metal roofing shingle 200-9 and the tenth metal roofing shingle 200-10 are installed in the second row on the roof deck 300, such that an end of the first layer 210 of the ninth metal roofing shingle 200-9 contacts an end of the first layer 210 of the tenth metal roofing shingle 200-10. In some embodiments, the tenth metal roofing shingle 200-10 overlap the sidelap 221 of the ninth metal roofing shingle 200-9.

In some embodiments, as FIG. 1B shows, the rows are installed in an array relative to one another such that, for example, the butt joints between the metal roofing shingles 200 in one row are aligned with the butt joints between the metal roofing shingles 200 in the row that is immediately above and/or immediately below.

With reference to FIG. 2, which shows a schematic side view of the first metal roofing shingle 200-1 and the fourth metal roofing shingle 200-4 installed on the roof deck 300, taken along line II-II from FIG. 1A, the second end 215 of the first metal roofing shingle 200-1 is positioned or otherwise installed within the first channel 212 of the fourth metal roofing shingle 200-4, and the first end 211 of the fourth metal roofing shingle 200-4 is positioned or otherwise installed within the second channel 216 of the first metal roofing shingle 200-1.

With reference to FIGS. 1A and 3, in some embodiments, the metal roofing shingle 200 includes a nail zone 225 on the headlap 223, the nail zone 225 receiving the fasteners 400 that secure the metal roofing shingle 200 to the roof deck 300. In some embodiments, the fasteners 400 penetrate both the metal roofing shingle 200 and the roof deck 300.

In some embodiments, as described, one or more of the metal roofing shingles 200 are installed directly on the roof deck 300, such that there is no intervening layer such as an underlayment between the metal roofing shingles 200 and the roof deck. In some embodiments, one or more of the metal roofing shingles 200 are installed indirectly on the roof deck 300, such that there at least one intervening layer, such as but not limited to an underlayment, between the metal roofing shingles 200 and the roof deck.

FIG. 5 is a schematic top view of one of the metal roofing shingles 200 of FIG. 1A, in accordance with some embodiments of the invention. As FIG. 5 shows, in some embodiments, the metal roofing shingles 200 include two sidelaps 221—one on each end of the second layer 220, such that another sidelap 221 is opposite to the sidelap 221 shown in FIGS. 1A, 3, and 4, for example. In some embodiments, when metal roofing shingles 200 include two sidelaps 221, the metal roofing shingles 200 are installed in a same row of the roof deck 300 such that the sidelaps 221 of the metal roofing shingles 200 at least partially overlap one another. In some embodiments, the roofing system 100 includes one or more covers and/or other components that cover the overlapping sidelaps 221 of the metal roofing shingles 200.

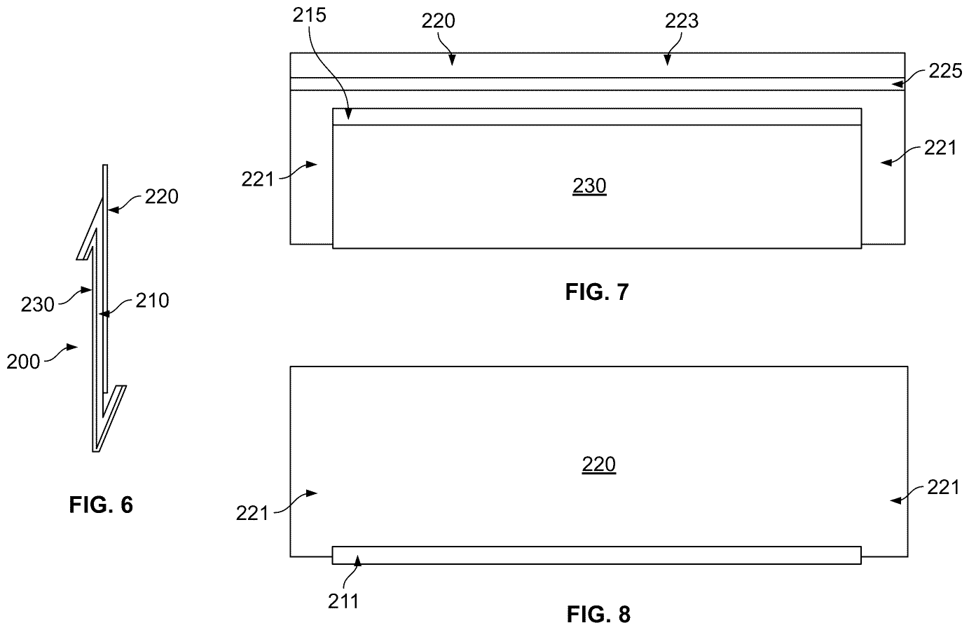

FIG. 6 is a schematic side view of one of the metal roofing shingles 200, FIG. 7 is a schematic top view of the metal roofing shingle 200 of FIG. 6, and FIG. 8 is a schematic bottom view of the metal roofing shingle of FIG. 6, in accordance with some embodiments of the invention. As shown in FIGS. 6-8, in some embodiments, the metal roofing shingle 200 includes a third layer 230. In some embodiments, the first layer 210 is between the second layer 220 and the third layer 230. In some embodiments, the first layer 210, the second layer 220, and/or the third layer 230 of the metal roofing shingle 200 are as described above. Thus, in some embodiments, the first layer 210 of the metal roofing shingle 200 is a metal layer, the second layer 220 of the metal roofing shingle 200 is a polymer layer, and/or the third layer 230 of the metal roofing shingle 200 is a polymer layer.

In some embodiments, the metal roofing shingle 200 of FIGS. 2-4, and/or the metal roofing shingle 200 of FIG. 5, includes the third layer 230.

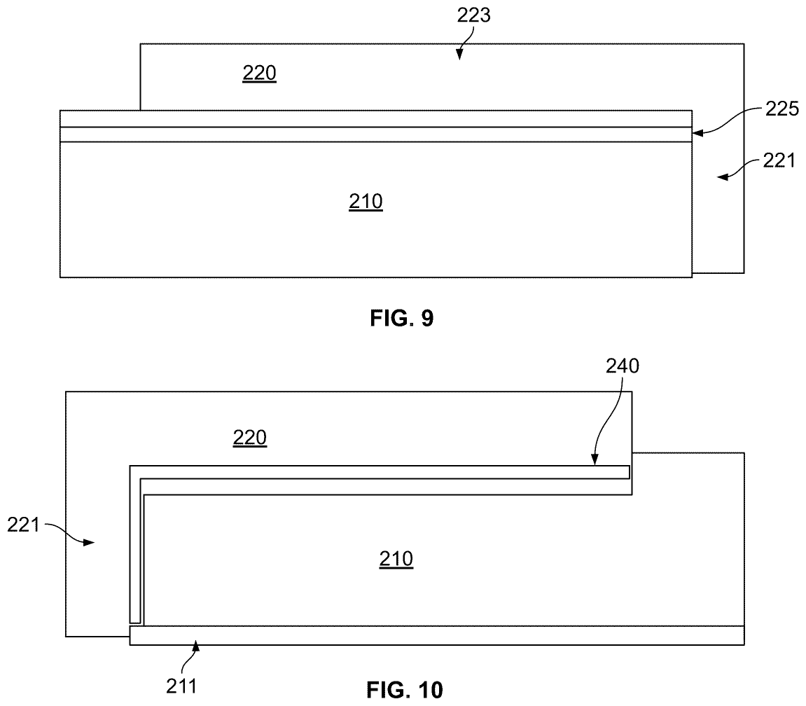

FIG. 9 is a schematic top view of one of the metal roofing shingles 200, and FIG. 10 is a schematic bottom view of the metal roofing shingle 200 of FIG. 9, in accordance with some embodiments of the invention. As FIGS. 9 and 10 show, the metal roofing shingle 200 includes the first layer 210 and the second layer 220. In some embodiments, the first end 211 of the first layer 210 is folded over the second layer 220. In some embodiments, the second layer 220 does not cover an entire back surface of the first layer 210. In some embodiments, the second layer 220 includes one sidelap 221, and the headlap 223. In some embodiments, the nail zone 225 is on the first layer 210. In some embodiments, the second layer 220 is adhered the first layer 210 with an adhesive applied in the adhesive area 240 between the first layer 210 and the second layer 220. In some embodiments, the adhesive is applied in one or more strips of adhesive. In some embodiments, the adhesive is applied as one or more spots of adhesive. In some embodiments, an adhesive is also applied to a surface of the folded first end 211, which adheres the metal roofing shingle 200 to another metal roofing shingle and/or to the roof deck 300 when installed in the roofing system 100.

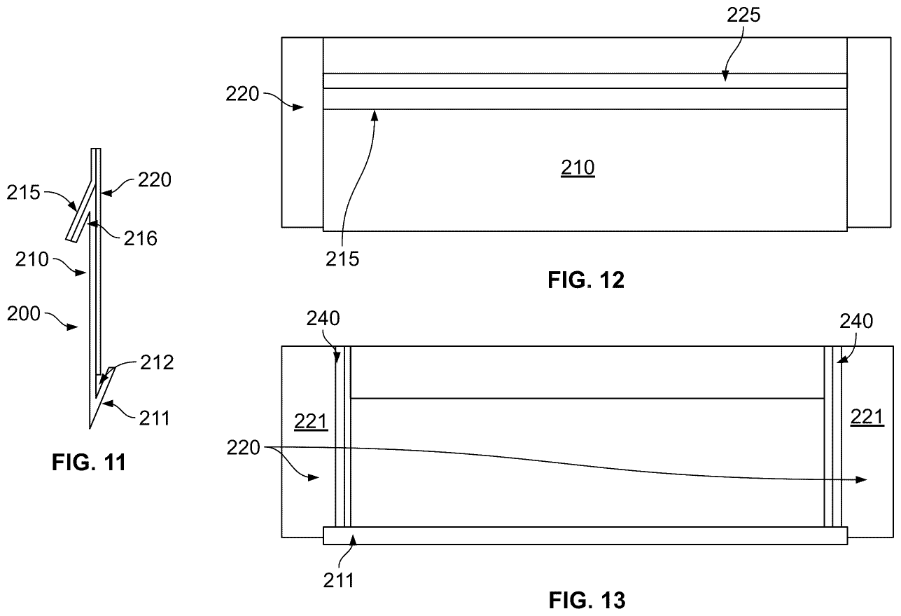

FIG. 11 is a schematic side view of one of the metal roofing shingles 200, FIG. 12 is a schematic top view of the metal roofing shingle 200 of FIG. 11, and FIG. 13 is a schematic bottom view of the metal roofing shingle 200 of FIG. 11, in accordance with some embodiments of the invention. As shown in FIGS. 11-13, the metal roofing shingle 200 includes the first layer 210 and the second layer 220. In some embodiments, the first end 211 of the first layer 210 is folded over the second layer 220, thereby providing the first channel 212. In some embodiments, the first layer 210 includes the second end 215, which is folded, thereby providing the second channel 216. In some embodiments, as FIG. 11 shows, the first layer 210 is a sheet that is folded to form both the first channel 212 and the second channel 216.

As FIG. 13 shows, in some embodiments, the second layer 220 does not cover an entire back surface of the first layer 210. In some embodiments, the second layer 220 includes two sidelaps 221. In some embodiments, the nail zone 225 is on the first layer 210. In some embodiments, the second layer 220 is adhered the first layer 210 with an adhesive applied in the adhesive areas 240 between the first layer 210 and the second layer 220. In some embodiments, the adhesive is applied in one or more strips of adhesive. In some embodiments, the adhesive is applied as one or more spots of adhesive. In some embodiments, an adhesive is also applied to a surface of the folded first end 211, which adheres the metal roofing shingle 200 to the roof deck 300 and/or to another metal roofing shingle 200 when installed in the roofing system 100. In some embodiments, either of the sidelaps 221 is omitted from the metal roofing shingle 200.

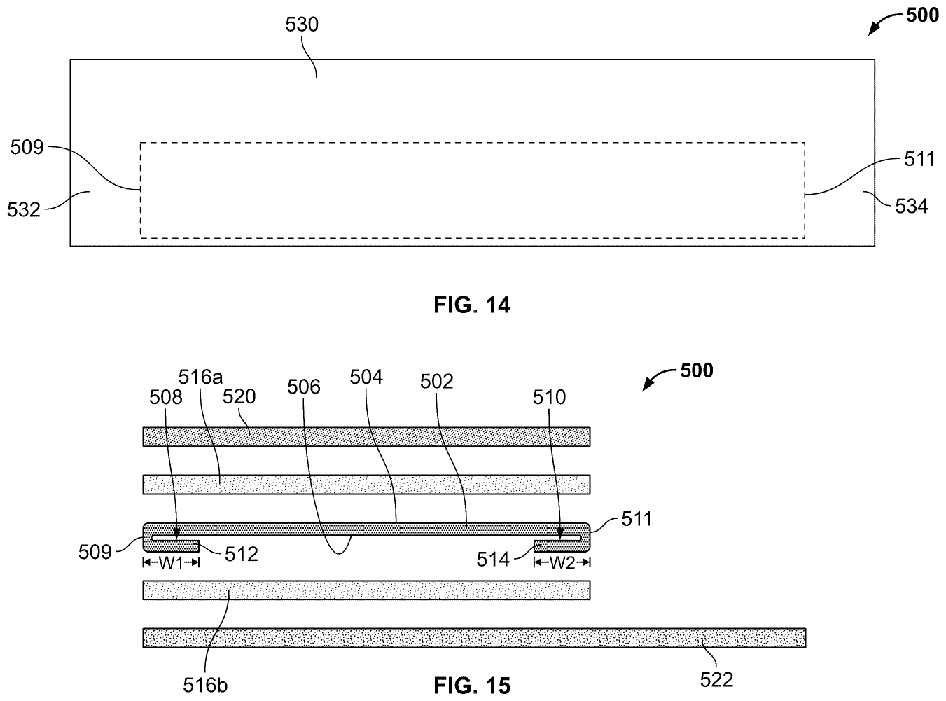

Referring to FIGS. 14 and 15, in some embodiments, a roofing shingle 500 includes a layer 502. In some embodiments, the layer 502 is composed of metal. In some embodiments, the layer 502 is composed of steel. In some embodiments, the steel has a gauge of 20 to 36. In some embodiments, the layer 502 is composed of galvanized steel. In some embodiments, the galvanized steel has a gauge of 20 to 30. In some embodiments, the layer 502 is composed of aluminum. In some embodiments, the aluminum has a gauge of 18 to 30.

In some embodiments, the layer 502 includes an upper surface 504 and a lower surface 506 opposite the upper surface 504. In some embodiments, the layer 502 includes a first hem portion 508 at a first end 509 thereof. In some embodiments, the layer 502 includes a second hem portion 510 at a second end 511 thereof.

In some embodiments, one or both of the first hem portion 508 and the second hem portion 510 is bent at the respective first end 509 and the second end 511.

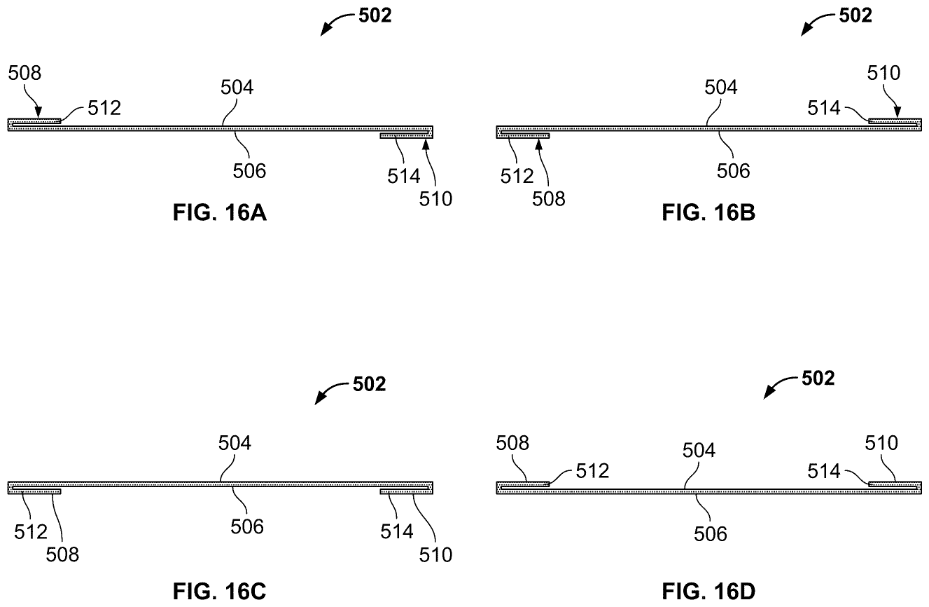

Referring to FIG. 16A, in some embodiments, at least a portion 512 of the first hem portion 508 is located above the upper surface 504 of the layer 502, and at least a portion 514 of the second hem portion 510 is located below the lower surface 506 of the layer 502. In some embodiments, the portions 512, 514 are parallel or substantially parallel to the respective upper surface 504 and lower surface 506.

Referring to FIG. 16B, in some embodiments, at least a portion 512 of the first hem portion 508 is located below the lower surface 506 of the layer 502, and at least a portion 514 of the second hem portion 510 is located above the upper surface 504 of the layer 502. In some embodiments, the portions 512, 514 are parallel or substantially parallel to the respective lower surface 506 and upper surface 504.

Referring to FIG. 16C, in some embodiments, at least a portion 512 of the first hem portion 508 and at least a portion 514 of the second hem portion 510 is located below the lower surface 506 of the layer 502. In some embodiments, the portions 512, 514 are parallel or substantially parallel to the lower surface 506.

Referring to FIG. 16D, in some embodiments, at least a portion 512 of the first hem portion 508 and at least a portion 514 of the second hem portion 510 is located above the upper surface 504 of the layer 502. In some embodiments, the portions 512, 514 are parallel or substantially parallel to the upper surface 504.

In some embodiments, the first hem portion 512 has a width W1 of 5 mm to 50 mm, e.g., 5 mm, 10, mm, 20 mm, 30 mm, 40 mm, or 50 mm, including ranges between any of the foregoing values. In some embodiments, the second hem portion 514 has a width W2 of 5 mm to 50 mm, e.g., 5 mm, 10, mm, 20 mm, 30 mm, 40 mm, or 50 mm, including ranges between any of the foregoing values.

In some embodiments, the layer 502 is a colored layer. In some embodiments, the layer 502 includes a color pigment. In some embodiments, the layer 502 includes a painted layer. In some embodiments, the upper surface 504 of the layer 502 is painted.

Referring back to FIGS. 14 and 15, in some embodiments, the roofing shingle 500 includes an encapsulant. In some embodiments, the encapsulant includes a first encapsulant layer 516a. In some embodiments, the first encapsulant layer 516a is above the layer 502. In some embodiments, the encapsulant includes a second encapsulant layer 516b. In some embodiments, the second encapsulant layer 516b is below the layer 502. In some embodiments, the first encapsulant layer 516a and the second encapsulant layer 516b encapsulate the layer 502. In some embodiments, each of the first encapsulant layer 516a and the second encapsulant layer 516b has a thickness of 250 μm to 1,000 μm, e.g., 250 μm, 300 μm, 400 μm, 500 μm, 600 μm, 700 μm, 800 μm, 900 μm, 1,000 μm, including ranges between any of the foregoing values. In some embodiments, each of the first encapsulant layer 516a and the second encapsulant layer 516b is a color layer. In some embodiments, each of the first encapsulant layer 516a and the second encapsulant layer 516b includes a color pigment. In some embodiments, the first encapsulant layer 516a and the second encapsulant layer 516b have a structure, composition, function and/or features disclosed in one or more of the aforesaid patent properties incorporated by reference herein.

In some embodiments, the roofing shingle 500 includes a frontsheet 520. In some embodiments, the frontsheet 520 is above the first encapsulant layer 516a. In some embodiments, the frontsheet 520 is composed of a polymer. In some embodiments, the frontsheet 520 is composed of a ETFE. In some embodiments, the frontsheet 520 is composed of one or more layers. In some embodiments, the frontsheet 520 has a thickness of 10 μm to 50 μm, e.g., 10 μm, 20 μm, 30 μm, 40 μm, or 50 μm, including ranges between any of the foregoing values.

In some embodiments, the roofing shingle 500 includes a backsheet 522. In some embodiments, the backsheet 522 is below the second encapsulant layer 516b. In some embodiments, the backsheet 522 is composed of a polymer. In some embodiments, the backsheet 522 is composed of thermoplastic polyolefin (TPO). In some embodiments, the backsheet 522 is composed of one or more layers. In some embodiments, the backsheet 522 has a thickness of 25 mils to 150 mils, e.g., 25 mils, 50 mils, 75 mils, 100 mils, 125 mils, or 150 mils, including ranges between any of the foregoing values.

In some embodiments, the frontsheet 520 and the backsheet 522 have a structure, composition, function and/or features disclosed in one or more of the aforesaid patent properties incorporated by reference herein.

In some embodiments, the layer 502, the first encapsulant layer 516a, the second encapsulant layer 516b, the frontsheet 520, and the backsheet 522 are laminated. In some embodiments, the layer 502 is embedded in the roofing shingle 500. In some embodiments, the roofing shingle 500 includes a headlap portion 530, a first sidelap portion 532, and a second sidelap portion 534.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

What is claimed is:

1. A roofing system, comprising:
a roof deck;
a plurality of photovoltaic modules installed on the roof deck,
wherein each of the photovoltaic modules comprises at least one solar cell; and
a plurality of metal roofing shingles installed on the roof deck adjacent the plurality of photovoltaic modules,
wherein the plurality of metal roofing shingles comprises at least a first metal roofing shingle and a second metal roofing shingle,
wherein each of the metal roofing shingles comprises:
a first layer,
wherein the first layer comprises a metal material, and
a second layer,
wherein the second layer comprises a polymer material,
wherein the second layer includes a nail zone comprising a plurality of fasteners extending therethrough, fastening the metal roofing shingle to the roof deck,
wherein the second layer is between the roof deck and the first layer.

2. The roofing system of claim 1, wherein the roof deck comprises a sloped roof deck.

3. The roofing system of claim 1, wherein the metal material comprises steel.

4. The roofing system of claim 1, wherein the polymer material comprises at least one of thermoplastic polyolefin (TPO) or ethylene tetrafluoroethylene (ETFE).

5. The roofing system of claim 1, wherein the second layer further comprises an intumescent material.

6. The roofing system of claim 5, wherein the intumescent material comprises expandable graphite.

7. The roofing system of claim 1, wherein the second layer directly contacts the roof deck.

8. The roofing system of claim 1, wherein an end of the first layer folds over an end of the second layer.

9. The roofing system of claim 1, wherein the second layer of the second metal roofing shingle extends beyond an end of the first layer of the second metal roofing shingle, thereby defining a sidelap,
wherein the second metal roofing shingle overlays the sidelap of the first metal roofing shingle.

10. The roofing system of claim 1, wherein the first layer comprises a first channel and a second channel on opposite ends of the first layer, wherein the first channel of the first metal roofing shingle is positioned within the second channel of the second metal roofing shingle.

11. The roofing system of claim 1, further comprising:
a plurality of fasteners,
wherein the plurality of fasteners comprises at least a first fastener and a second fastener,
wherein the first fastener penetrates the nail zone of the first metal roofing shingle and the roof deck, thereby installing the first metal roofing shingle on the roof deck,
wherein the second fastener penetrates the nail zone of the second metal roofing shingle and the roof deck, thereby installing the second metal roofing shingle on the roof deck.

12. The roofing system of claim 11, wherein the first fastener penetrates the first layer of the first metal roofing shingle.

13. The roofing system of claim 11, wherein the first fastener does not penetrate the first layer of the first metal roofing shingle.

14. The roofing system of claim 1, wherein the first layer of the first metal roofing shingle includes an embossed surface.

15. The roofing system of claim 1, wherein each of the metal roofing shingles further comprises a third layer, wherein the third layer comprises a polymer material, and wherein the first layer is between the second layer and the third layer.

16. The roofing system of claim 15, wherein the third layer comprises at least one of thermoplastic polyolefin (TPO), ethylene tetrafluoroethylene (ETFE), or styrene-butadiene-styrene (SBS).

17. A method, comprising:
obtaining a plurality of photovoltaic modules and a plurality of metal roofing shingles,
wherein the plurality of photovoltaic modules includes at least a first photovoltaic module,
wherein each of the photovoltaic modules comprises at least one solar cell,
wherein the plurality of metal roofing shingles comprises at least a first metal roofing shingle and a second metal roofing shingle,
wherein each of the metal roofing shingles comprises:
a first layer,
wherein the first layer comprises a metal material, and
a second layer,
wherein the second layer comprises a polymer material,
wherein the second layer includes a nail zone configured to receive a fastener;
installing the first photovoltaic module on a roof deck; and
installing the first metal roofing shingle and the second metal roofing shingle on the roof deck, adjacent to the first photovoltaic module, so that:
the second layer of the first metal roofing shingle is between the roof deck and the first layer of the first metal roofing shingle, and
the second layer of the second metal roofing shingle is between the roof deck and the first layer of the second metal roofing shingle.

18. The method of claim 17, wherein the installing the first metal roofing shingle and the second metal roofing shingle on the roof deck comprises:
installing the first metal roofing shingle adjacent to a side of the first photovoltaic module, in a first row on the roof deck; and
installing the second metal roofing shingle adjacent to the side of the first photovoltaic module, in a second row on the roof deck,
wherein the second row is above the first row on the roof deck.

19. The method of claim 17, wherein the installing the first metal roofing shingle and the second metal roofing shingle on the roof deck comprises:
installing the first metal roofing shingle adjacent to a side of the first photovoltaic module, in a first row on the roof deck; and
installing the second metal roofing shingle adjacent to the first metal roofing shingle, in the first row on the roof deck.

20. The method of claim 17, wherein the installing the first metal roofing shingle and the second metal roofing shingle on the roof deck comprises:
penetrating, with a first fastener, both of:
the nail zone of the second layer of the first metal roofing shingle, and
the roof deck, and
penetrating, with a second fastener, both of:
the nail zone of the second layer of the second metal roofing shingle, and the roof deck.
